(19) United States
(12) Patent Application Publication
(10) Pub. No.: US 2013/0285950 A1
(43) Pub. Date: Oct. 31, 2013

(54) ELECTRONIC DEVICE HAVING STRUCTURE FOR FIXING TOUCH PANEL THEREOF

(71) Applicants: HON FU JIN PRECISION INDUSTRY (SHENZHEN) CO., LTD., Shenzhen (CN); HON HAI PRECISION INDUSTRY CO., LTD., New Taipei (TW)

(72) Inventors: TING-TING ZHAO, Shenzhen (CN); HE-LI WANG, Shenzhen (CN)

(73) Assignees: HON HAI PRECISION INDUSTRY CO., LTD., New Taipe (TW); HON FU JIN PRECISION INDUSTRY (ShenZhen) CO., LTD., Shenzhen (CN)

(21) Appl. No.: 13/860,735

(22) Filed: Apr. 11, 2013

(30) Foreign Application Priority Data
Apr. 27, 2012 (CN) 201210126680.2

(51) Int. Cl. G06F 3/041

(52) U.S. Cl. CPC G06F 3/041
USPC 345/173

(57) ABSTRACT

An electronic device includes an upper cover, a lower cover engaged with the upper cover, a touch panel, a circuit board fixed to the lower cover, at least one connector mounted on the circuit board, and a support element. A top surface of the touch panel is fixed to the upper cover. The support element includes a mount and at least one support. The mount is mounted on the circuit board and covers the at least one connector. The at least one support protrudes from the mount and resists against a bottom surface of the touch panel.

### BACKGROUND

1. Technical Field

The present disclosure relates to electronic devices, and particularly to an electronic device having a structure for fixing a touch panel of the electronic device.

2. Description of Related Art

Touch panels of some electronic devices are fixed to the upper covers with double-sided adhesives. Thus, the touch panel may be detached easily from the upper cover if the electronic device is shaken or hit by an external force. A structure for fixing the touch panel includes a number of fixing members, two ends of which resisting against the touch panel and the main board of the electronic device. However, the structure for fixing the touch panel takes up much room and increases the size of the electronic device.

Therefore, what is needed is an electronic device having a structure for fixing a touch panel thereof to overcome the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an exemplary embodiment of an electronic device having a structure for fixing a touch panel.

FIG. 2 is an exploded view of the electronic device of FIG. 1.

FIG. 3 is a partial isometric view of the electronic device of FIG. 1.

### DETAILED DESCRIPTION

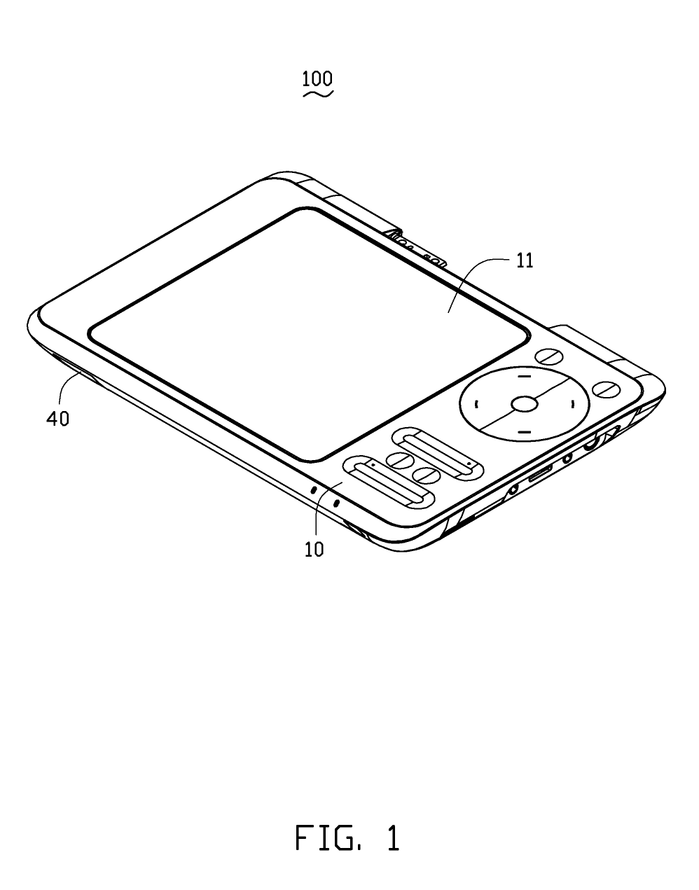

Referring to FIG. 1, an electronic device 100 is shown as an exemplary embodiment. In the embodiment, the electronic device 100 is a digital video disc (DVD) player. The electronic device 100 includes an upper cover 10 and a lower cover 40 engaged with the upper cover 10. The upper cover 10 defines a receiving space 11 for receiving a DVD disc.

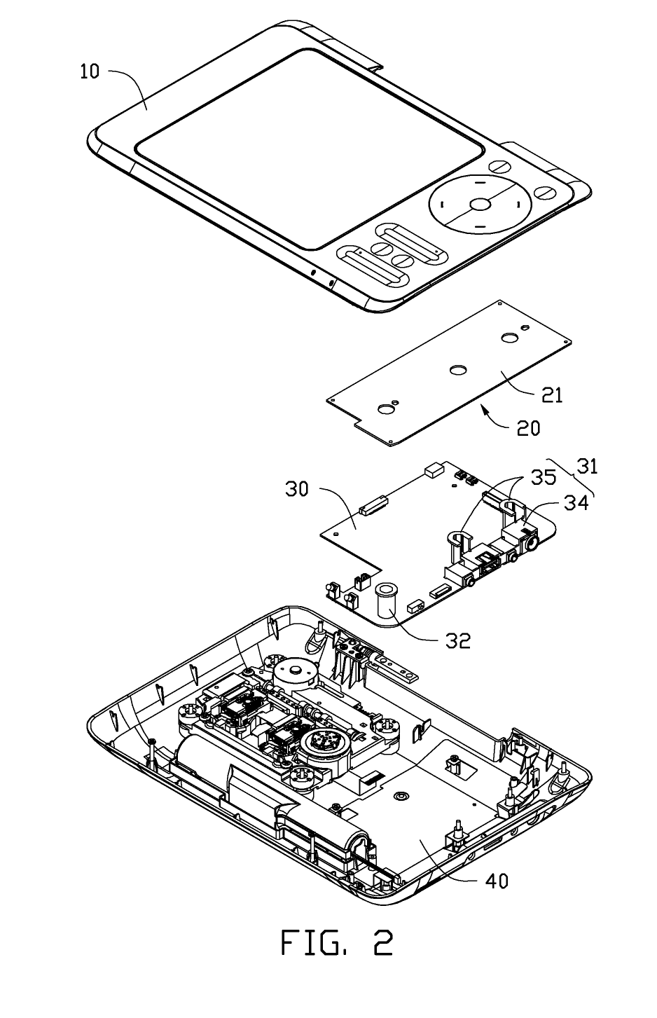

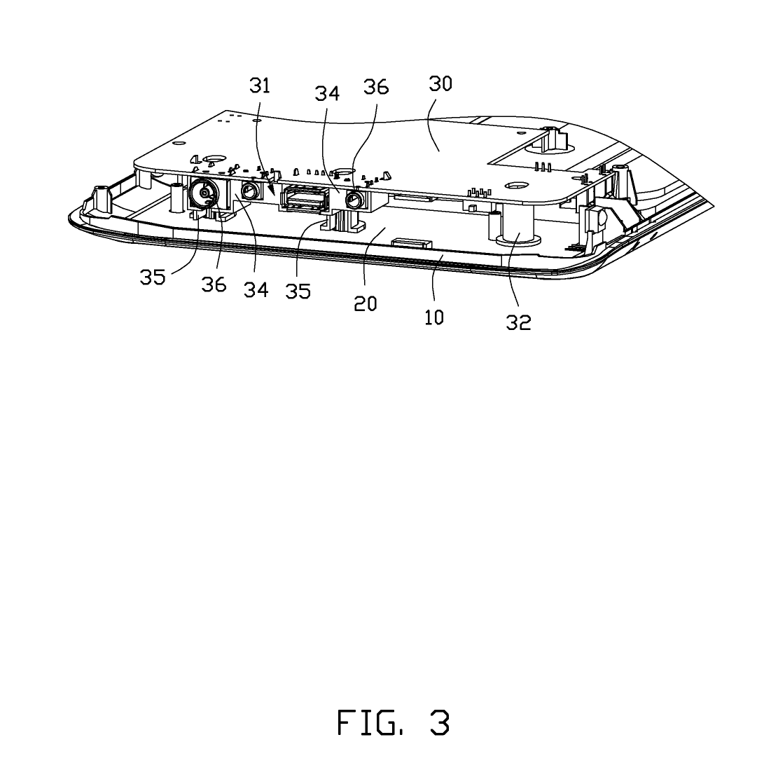

Referring to FIGS. 2 and 3, the electronic device 100 further includes a touch panel 20 and a circuit board 30. The touch panel 20 and the circuit board 30 are arranged between the upper cover 10 and the lower cover 40 in sequence. In the embodiment, a top surface 21 of the touch panel 20 is fixed to the inner surface of the upper cover 10 with double-sided adhesives. The circuit board 30 is fixed to the lower cover 40 via screws (not shown).

At least one connector 36 is soldered to the circuit board 30. One exemplary connector 36 can be connected with an earphone to transmit audio signals. A support element 31 is mounted on the circuit board 30 and covers the connector 36. The support element 31 resists against the touch panel 20. Thus, the touch panel 20 is further stably fixed to the upper cover 10.

The support member 31 includes a mount 34 and at least one support 35 protruding from the top of the mount 34. The mount 34 and the at least one support 35 are made of the same material. The top of the support 35 is approximately U-shaped and resists against the bottom surface of the touch panel 20 for supporting the touch panel 20. In the embodiment, the number of the supports 35 is two. In other embodiments, the number of the supports 35 can vary according to need.

A post 32 protrudes from the circuit board 30. The post 32 also resists against the touch panel 20 for further strengthening the force for fixing the touch panel 20 to the upper cover 10.

With such configuration, the support element 31 takes up less room and helps to fix the touch panel 20 to the upper cover 10 of the electronic device 100. Furthermore, the post 32 protruding from the circuit board 30 and resisting against the touch panel 20 further strengthens the force for fixing the touch panel 20. Compared with the conventional structure for fixing touch panels, the support element 31 has an advantage of taking up less room and helping to decrease the size of the electronic device 100.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
an upper cover;
a lower cover engaged with the upper cover;
a touch panel comprising a top surface fixed to the upper cover;
a circuit board fixed to the lower cover;
at least one connector mounted on the circuit board; and
a support element comprising:
a mount mounted on the circuit board and covering the at least one connector; and
at least one support protruding from the mount and resisting against a bottom surface of the touch panel.

2. The electronic device as described in claim 1, further comprising a post protruding from the circuit board and resisting against the touch panel.

3. The electronic device as described in claim 1, wherein the top surface of the touch panel is fixed to the upper cover with double-sided adhesives.

4. The electronic device as described in claim 1, wherein the mount and the at least one support are made of the same material.

5. The electronic device as described in claim 1, wherein the support element is U-shaped.
